(19) United States
(12) Patent Application Publication
(10) Pub. No.: US 2016/0302030 A1
(43) Pub. Date: Oct. 13, 2016

(54) Location-Based Real-Time Contextual Data System

(71) Applicant: Visor, Inc., New York, NY (US)

(72) Inventor: Jason White, New York, NY (US)

(21) Appl. No.: 14/684,073

(22) Filed: Apr. 10, 2015

(51) Int. Cl. H04W 4/02; H04L 29/08; G06Q 30/02; H04L 29/06

(52) U.S. Cl. CPC H04W 4/02; H04L 67/42; H04L 67/18; G06Q 30/0208

(57) ABSTRACT

Systems and methods for presenting requests related to a location to users within a collective network. In some implementations, the methods include receiving, from a first user within a collective network, a request identifying (i) a location and (ii) a request for information related to the location; publishing the request over the collective network with a status indicating whether the request has been fulfilled; providing, for a plurality of users within the collective network, a user interface for responding to the submission from the first user. receiving, from a second user within a collective network, a response including information related to the location; determining the responsiveness of the response to the request based on at least the included information related to the location; and in response to determining the responsiveness of the response, updating a status for the request indicating that the request has been fulfilled.

### CROSS-REFERENCE TO RELATED APPLICATIONS

This application claims priority to U.S. application Ser. No. ______, filed on Apr. 10, 2014.

### FIELD

The present specification relates to network communications and more particularly, digital communications architecture.

### BACKGROUND

Generation of location-specific data allows a broad platform for investigating network communication events between various users. Delivery or request of such data may be based on information from public online forums, social media networks, or common device-to-device communication platforms such as telephone calls, email, and text-based messaging. Existing platforms utilize historical data such as previous posts, messages or online interactions to determine relevant insights on network communication.

### SUMMARY

In one general sense, a data system may manage the supply and demand of real-time, context-specific data generated within a specified location and process the communications through an interface that connects multiple client devices to a collective network, enabling users to submit relevant requests based on the specified location, and other users to respond to the requests through interactions over the collective network. The data monitored by the collective network may only be accessed under specific contexts or limited time periods to prevent the processing of inaccurate and irrelevant data within the collective network. The advantages include greater real-time insights to users about general requests and trends, improved responsiveness to specified requests by creating the ability to identify context-specific usage patterns that may influence subsequent user interactions over the collective network.

Implementations may include one or more of the following features. For example, a computer-implemented method of presenting requests related to a location to users within a collective network, the methods including: receiving, from a first user within a collective network, a request identifying (i) a location and (ii) a request for information related to the location; publishing the request over the collective network with a status indicating whether the request has been fulfilled; providing, for a plurality of users within the collective network, a user interface for responding to the submission from the first user; receiving, from a second user within a collective network, a response including information related to the location; determining the responsiveness of the response to the request based on at least the included information related to the location; and in response to determining the responsiveness of the response, updating a status for the request indicating that the request has been fulfilled.

These and other versions may each optionally include one or more of the following features. For instance, in some implementations, providing, by a server computer system, a transmission to a client device to provide a user interface.

In some implementations, the user interface for responding to the request is a map user interface identifying (i) an interactive icon indicating the location of the request, (ii) the request for information related to the location, and (iii) the status of the submission submitted by the first user.

In some implementations, the received request includes a reward for providing a responsive response to the request.

In some implementations, the methods further include calculating a confidence level of the received request, where the confidence level of the received request reflects a likelihood that one or more users within the collective network will respond to the request.

In some implementations, the methods may also include: comparing the confidence level for the received request to a threshold value for the confidence level; determining that the confidence level for the received request is lower than the threshold value; based on at least determining that the confidence level for the received request is lower than the threshold value, determining that that the received request is invalid; and calculating a confidence level of the received response, where the confidence level of the received response reflects a likelihood that the response includes information identified as satisfying the request.

In some implementations, after receiving the request including information related to the location, the methods may include performing a routing operation directed towards a plurality of users within the collective network. In some examples, the performing the routing operation directed towards a plurality of users within a collective network is based at least on a confidence level of the received request, where the confidence level of the received request reflects a likelihood that a second user within the collective network will respond to the request. In some instances, the routing operation includes prioritizing the publishing of the received request based at least on the number of other requests received over the collective network within a particular time period, determining the number of users within a particular distance from the location referenced in the received request.

In some implementations, the methods may also include: generating a set of suggested features for the request to improve the likelihood of receiving a response based at least on determining the number of users within a particular distance from a location referenced in the received request; providing, by a user interface, the set of suggested features to a user device of the first user.

In some implementations, the methods may also include: before the second user submits the response, determining a distance score between a location of the second user and the location identified in the request; determining that the distance score between the GPS location of the user device of the second user and the location identified in the request is below a threshold value; in response to determining that the distance score between the location of the second user and the location identified in the request is greater than the threshold value, determining that the second user is ineligible to claim the request; after receiving the response from the second user including information related to the location identified in the request, determining a second distance score between a location of the second user and the location identified in the request; determining that the second distance score between the location of the second user and the location identified in the request is below a threshold value; and in response to determining that the second distance score between the location of the second user and the location identified in the request is greater than the threshold value, determining that the response is invalid.

In some optional implementations, the methods may include: receiving context data from the first user over the collective network; determining a likely context associated with the first user, based on at least a portion of the context data; receiving context data from the second user over the collective network; determining a likely context associated with the second user, based on at least a portion of the context data; comparing the likely context associated with the first user with the likely context associated with the second user; determining that the likely context from the first user is relevant to the second user, based at least on comparing the likely context associated with the first user with the likely context associated with the second user; selecting one or more notifications to send to the second user based at least on determining that the likely context from the first user is relevant to the second user; and providing, by a user interface, the one or more selected notifications to the second user.

In some examples, the context data from the first user includes location information submitted by the first user to the collective network within a particular period of time. In other examples, the one or more selected notifications to the second user may include suggestions to submit information to the collective network.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 is a block diagram of an exemplary arrangement of a network apparatus for requesting and publishing contextual data.

FIG. 2 illustrates how client devices may submit and respond to location requests over a collective network.

FIG. 3A is an exemplary user interface for a map-environment used to track real-time location data.

FIG. 3B is an exemplary user interface for creating a new location request.

FIG. 3C is an exemplary user interface for a location feed used to monitor context-based data within a location.

FIG. 4A shows an exemplary flow diagram illustrating a calculation for confidence level for a location request.

FIG. 4B shows another exemplary flow diagram illustrating predictive modeling of a location request.

### DETAILED DESCRIPTION

Communication networks, such as social media networks, enable widespread collection of user interactions (e.g., posts, preferences, friend connections) which may be gathered using data generated by an interface coupled to a collective network through which the user interactions may be routed or shared. An interface, such as a mobile application, may be configured to transmit a stream of user requests representing user behavior within a location to a data collection system, for example, a data server. Client devices may be configured to the interface with the data collection system to access content gathered by the interface.

An interface is used to present multiple sources of digital content. For example, a mobile application, or a web-based application, may be accessed by multiple client devices. The client devices generally use a wired or a wireless network connection to communicate with the data center (e.g., through a fixed network gate-way or a broadband connection), which in turn, makes the digital content from the interfaces available. More particularly, the data collection system in the data center devices may enable clients to intelligently navigate the interface and to present content from one or more client devices within the collective network, independently or in a simulated manner.

Furthermore, using the interface, a user may provide a context-specific request within a specified location that enables the user to gain access to relevant information over the collective network. The interface receives the request and may aggregate similar requests from nearby locations and collect information from similar requests as well as collecting information about nearby user activity to generate suggestions for increasing the likelihood of receiving a response. The interface may also allow these other users to insert contextual information in a response and notify the original user that the submitted request has been answered. The original user then may review the data contained in the response and accept the request.

To illustrate, a user may submit a request through a mobile application to determine if there is a current waitlist for a restaurant in a different location from where he may be located. The mobile application may allow the user to submit a request to a collective network that tracks real-time posts submitted by all users to the application. The mobile application may transmit the request to a data server that compares the information within the request to previous requests about the restaurant to determine if similar requests have been submitted by other users through the mobile application. The data server may publish the user's request to the network so that users nearby the restaurant location may receive a notification that another user is requesting information related to wait times at the restaurant. In some examples, responding users nearby the restaurant location may submit a response to the request by posting information about the restaurant on the collective network. In other examples, responding users may submit a response to the request privately by sending a message directly to the requesting user.

In one particular implementation, the data server may receive such responses and determine, based on the quality of the response (e.g., accuracy, length of the response, presence of required information), whether response is an adequate response to the request. The data server may subsequently publish the information by the users nearby the restaurant for a specified time period so that all users can access the information over the collective network. Other implementations are discussed more in detail within this specification.

There may be different validation techniques by the data server to determine whether either of the location request or the response are satisfactory submissions through the collective network to prevent inaccurate or irrelevant information from being published on the collective network. For example, the data server may calculate a confidence level of a submitted location request based on a set of attributes that indicate the authenticity of the request and the likelihood of receiving a response. For instance, the data server may cross-reference the specified location within the request with online resource to verify that the location actually exists. The data server may also perform trend analysis on requesting user's previous submitted requests, analyze the terms and information included within the request, or retrieve information from additional application program interfaces to generate further information about the location, including an analysis of other requests and users nearby the location. The data server may calculate a confidence level for the location request, which represents level of certainty that the request will be adequately answered/fulfilled.

In one implementation, the data server may then compare the calculated confidence level to a threshold value based on the context of the request (e.g., location, type of location, street traffic nearby the location, number of users nearby the location, other requests nearby the location, urgency of the request), to determine whether to provide a list of suggested options to the requesting user to increase the likelihood of receiving a response.

In some implementations, the data server may also validate responses to the request submitted by other users to prevent duplication of data within the collective network or to protect integrity of the information within the network. For example, the data server may utilize location validation to only accept responses from users within a range from the location to prevent false responses. The data server may also compare the information within the response and request to determine a confidence level of the response, which represents the likelihood that the response includes high quality information. For example, the data server may also assess the reliability of the user sending the response based on the responding user's response history.

Thus, a requesting user may use the interface connected to a collective network to retrieve real-time location-based information by submitting a location request to a collective network that connects client devices in different locations. The information provided by a responding user may additionally be used to generate real-time insights on the location specified within the location request that may be published to the collective network. This experience may improve access to context-specific information as well as improve the quality of data generated through connected networks by verifying the information provided by users within the collective network. Similarly, the methods described within this specification may enable a requesting user to receive predictive suggestions to increase the likelihood of receiving a response. The methods may also be used to track a posting users' historical posts to predict context-specific user preferences and other relevant information based on analyzing the posting user's online activity within the connected network.

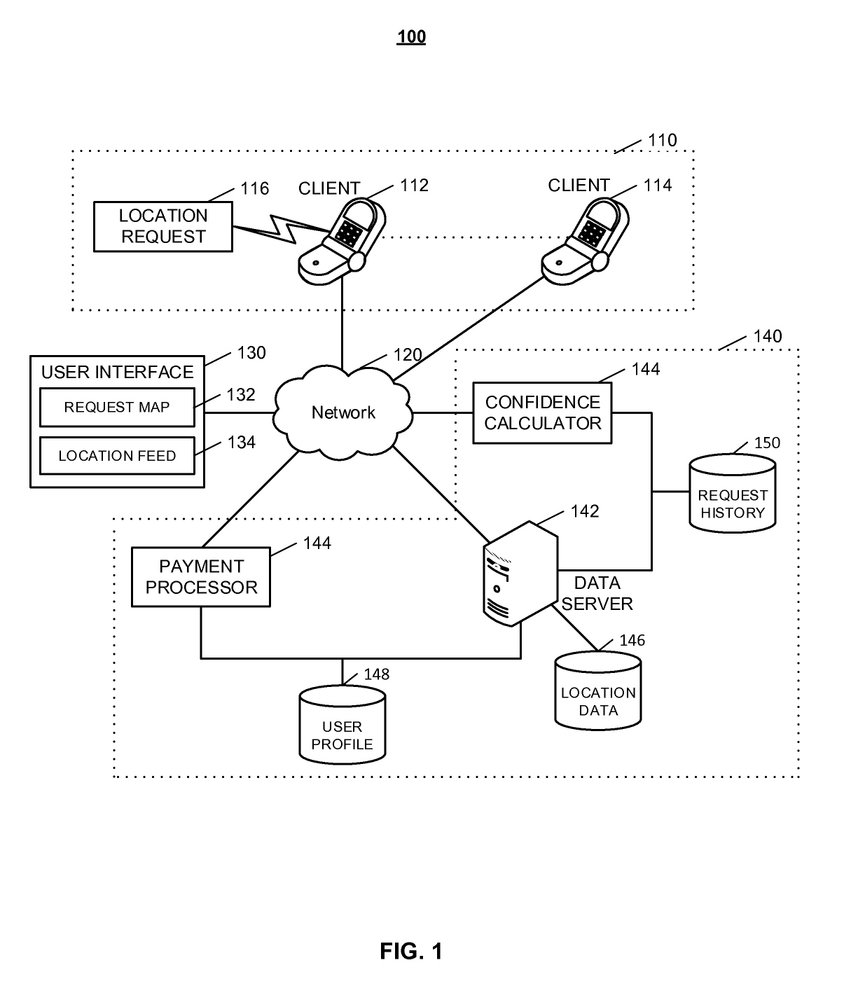

FIG. 1 is a block diagram of an exemplary arrangement of a network apparatus for requesting and publishing contextual data. The system 100 enables communications between a collective network 110, an interface 130, and a data collection system 140 over a network 120.

The collective network 110 generally includes one or more clients 112, 114, configured to receive and transmit digital content (e.g., streams of data units) within a location request 116. The collective network 110 includes a communications interface to transmit the digital content to the data collection system 140. The collective network 110 is then configured to process the digital content and enable the one or more clients, 112, 114, to access the content through the interface 130.

The network 120 typically includes hardware and/or software capable of enabling direct or indirect communications between the collective network 110, the interface 130, and the data collection system 140, and other devices in the communications system 100. As such, the network 120 may include a direct link between the one or more clients 112, 114 and the other devices, or it may include one or more networks or subnetworks between them (not shown). Each network or subnetwork may include, for example, a wired or wireless data pathway capable of carrying and receiving data. Examples of delivery network include the Internet, the World Wide Web, a WAN (“Wide Area Network”), a LAN (“Local Area Network”), analog or digital wired and wireless telephone networks, radio, television, cable, satellite, and/or any other delivery mechanisms for carrying data.

The user interface 130 generally includes a request mapping 132 and a location feed 134. The user interface 130 may be presented on the one or more clients 112, 114 to allow users to generate digital content over the network 120.

The request map 132 is configured to show all location requests 116 submitted to the collective network 110 on a map display. In one example, request map shows all location requests within a specific locality (e.g., one mile radius) of the location request 116 submitted on the client 112. In other examples, the request map 132 may show all location requests within a specific time period (e.g., in last thirty minutes) of the location request 116 submitted on the client 112. The request map 132 may also be also configured to allow a user to access information about the other location requests such as text submitted with the request, request history within the specified locations, and the profile information of the users submitting the request.

The user interface 130 may include a location feed 134. Generally, the location feed 134 shows relevant posts for a location recently submitted to the collective network 110. For example, the posts may include pictures of locations, text information indicating whether there are service delays, or written posts about a user's experience at the location. The location feed 132 may also include alerts or notifications for users that have submitted a request. For example, the location feed 134 may notify a user that other users have submitted similar requests about the same location within a short period of time. The location feed 132 allows users to track posts submitted by other users by allowing users to click a hyperlink on that redirects the user to the other user's profile page.

The data collection system 140 includes computer devices configured to receive and process digital content from the collective network 110. For example, a mobile device may transmit a location request to the data server 142 through a broadband connection. The data collection system 140 may be connected to the collective network 110 through the network 120.

The data collection system 140 includes a data server 142 that stores data related to the location request 116. For example, the data server 142 may store location data 146 that represents the corresponding GPS signal data from the client device 112 used to generate the location request 116.

The data collection system also includes a confidence calculator 144 that may process the location request 116 and calculate a corresponding confidence level for the location request 116. The confidence level may be a calculated score that represents the likelihood that the submitted request will receive a response based on based on the number of users nearby the location identified within the request, characteristics of the nearby users that indicate whether they are likely to respond, and the number of nearby requests near the location that may impact the response. For example, the confidence calculator 144 may calculate a high confidence level if there are a large number of users nearby the identified location based on determining that the probability of receiving a response is high. In another example, the confidence calculator 144 may attenuate the confidence level if it determines there are multiple other requests nearby the identified location, which may indicate that the responding users may choose to fulfill other requests nearby the location.

In other implementations, the context calculator 144 may perform a trend analysis to determine how reliable the location request 116 may be based on the requesting user's prior request submissions over the collective network. In this example, if the requesting user has a history of submitting a large quantity of location requests that are unresolved, the confidence calculator 144 may determine that the location request 116 has a low confidence level. In another example, the confidence calculator 144 may check the contents of the location request 116 to determine whether the information requested contains an actual request. For instance, the confidence calculator 144 may cross-reference a venue description included within the location request against external sources such as online webpages to determine if the user has made an error within the location request.

In another example, the confidence calculator 144 may compare the location request 116 against a request history 150 to determine if the submitted request may be a duplicate of a similar request for the same location submitted within a short time frame. For example, the confidence calculator 144 may filter the request history stored on the data server 142 for the venue described in the location request 116 and perform a character comparison between the text in the location request 116 and other requests within the request history 150 to determine if they are substantially similar. In another example, the confidence calculator 144 may compare the location request 116 against previous requests within the request history 150 submitted by the same user. In such examples, the request validator may determine if the user has previously submitted a similar location request.

In some implementations, the confidence calculator 144 may also calculate a confidence level for a response to a location request submitted by a responding user. In these implementations, the confidence level for the response represents the likelihood that that the response contains high-quality information. For example, the confidence calculator 144 may user the response history of the responding user to determine if the user has a strong track record for successfully fulfilling prior location requests. In another example, the confidence calculator 144 may determine, based on information provided within the response, whether the information is accurate by comparing the response with external sources such as internet posts, and prior data provided within the collective network.

In other implementations, the confidence calculator 144 may prioritize responses with higher confidence levels over responses with lower confidence levels in allowing a responding user to claim a location request. For example, if there are multiple candidate responses submitted by nearby users to the identified location, the confidence calculator 144 may initially determine the confidence values for all of the candidate responses and only allow the responding user that submits the response with the highest confidence level to claim the location request.

The data collection system 144 also includes a payment processor 144 that accesses a user profile 148 to set reward points for location requests and reward users that successfully respond to such location requests. For example, the payment processor may receive a signal from the confidence calculator 144 that there was a successful response to the location request 116 and subsequently process the reward payment by transferring the corresponding amount to the user submitting the response. In such examples, the payment processor 144 may access the user profile 148 of the requesting user to initiate a charge on the payment method indicated within the user profile 148 and create a user credit within another user profile for the responding user.

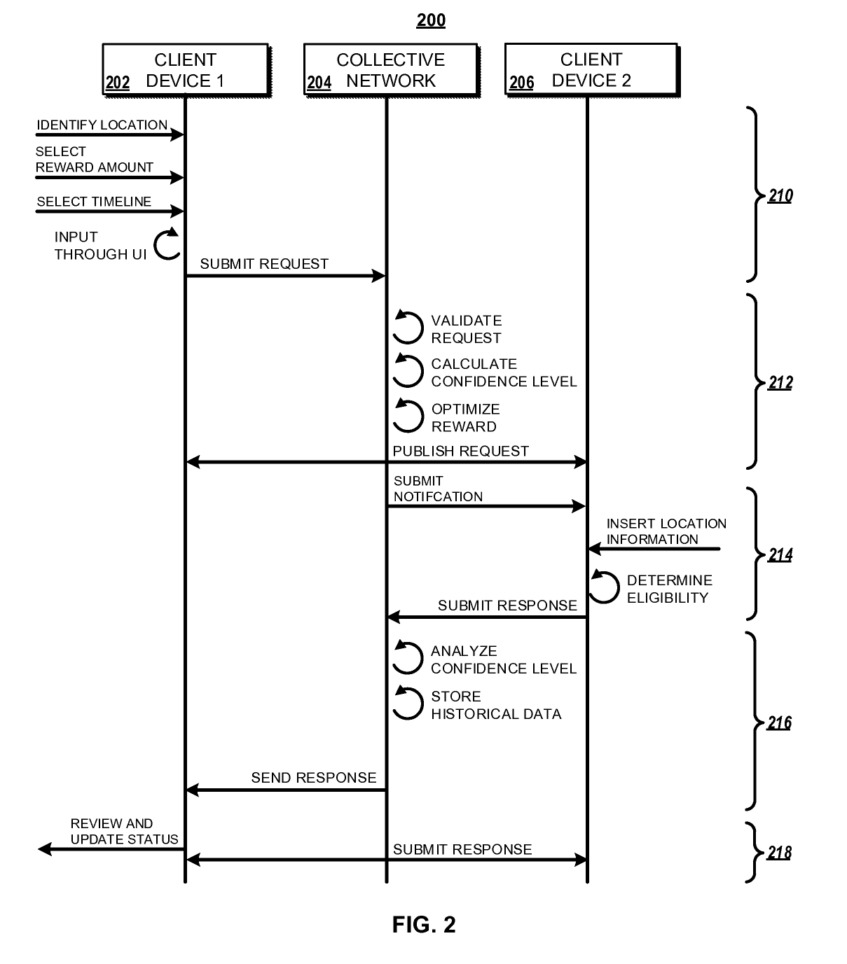

FIG. 2 illustrates an example of how client devices may submit and respond to location requests over a collective network. Briefly, a requesting user submits a location request to a collective network (210). The system receives the location request and processes it for publication over a collective network (212). A responding user submits a response to the location request (214). The system receives the response to the location request and analyzes it for submission over the collective network (216). Finally, the requesting user reviews the response and determines whether it satisfies the request (218).

The requesting user submits the location request device to the collective network (210). Initially, the system 200 provides a user interface such as a mobile application on the client device 202 to allow the user to provide details of the location request. For example, as indicated, the user may identify the location, select an appropriate reward amount for the request and set a deadline for when the request needs to be responded to. The user may then submit the request to the collective network 204 by transmitting the location request over a wireless or wired network such as a wireless LAN connection, an Ethernet connection or a cellular broadband connection.

The system receives the location request and processes it for publication over a collective network (212). For example, the system 200 may receive the location request submitted to the collective network 204 and transmit the location request to a data server for processing and storage. In such examples, the data server may initially validate the request to ensure that it is sufficient to receive a response, calculate a confidence level indicating its reliability, accuracy, and probability of receiving a response, and suggest or optimize the reward level that will increase the chances of receiving a response. For instance, the data server may determine that the location request is invalid because it references a location that no longer exists. In other instances, the data server may determine that the location request does not meet the requisite confidence level in reference to a minimum threshold value because it lacks sufficient details to receive a response. In other instances, the data server may determine, based on the number of users nearby the referenced location, that the reward may be insufficient to generate a response from a responding user. In such instances, the data server may submit a notification to the requesting user recommending a higher reward, or automatically increasing the reward when it is processed. Once the data server has processed the location request, it may publish the location request on the collective network for all users to access.

A responding user claims the location request (214). For example, the system 200 may send a notification to nearby users within a certain location range (e.g., one mile radius) from the location identified within the location request. For examples, the responding users receiving the notification are initially determined to be eligible to claim the request based on how close they are to the identified location relative to a threshold value. The responding users that are determined to be eligible to claim the request may respond to the location request by submitting the requested location information to the collective network 204 over a wireless or wired network such as a wireless LAN connection, an Ethernet connection or a cellular broadband connection. The system receives the response to the location request from eligible responding users and analyzes it for submission over the collective network (216). For example, as indicated, the system 200 may process the response to the location request by analyzing the confidence level of the response, and store historical data relating to the response. For instance, the system 200 may determine whether the response has a high confidence level by comparing the information requested against the information contained within the response. The system 200 may also compare the information within the response against a prior history of responses stored within data server to determine whether the information is accurate and reliable.

In some implementations, the system 200 may use the confidence levels of multiple received responses to determine which responding user may respond to the location request. For example, if the location request has multiple eligible responding users that claim the location request, the system 200 may calculate confidence levels associated with each claimed response and only allow the response with the highest confidence level to send a response to the requesting user. For instance, the system 200 may perform a trend analysis on each responding user's response history, percentage of fulfilled responses, and quality of information provided to determine which response has the highest confidence value.

In other implementations, the system 200 may use a threshold confidence level to prevent submitted responses that do not meet the threshold value from being claimed by the responding user. In such instances, the system 200 may only provide a subset of claimed responses to the requesting user and allow the requesting user to determine which claimed response he would like to allow. For example, if there are twenty claimed responses for the identified location, the system 200 may determine a threshold value and allow four or five responses that meet the threshold to be presented to the requesting user. In this example, the requesting user may choose the response based on his own set of preferences.

Finally, the requesting user reviews the response and determines whether it satisfies the request (218). For example, once the response is published, the requesting user may receive a notification that a response has been received to his location request. The requesting user may review the response to determine whether it resolves his request and provide feedback to the system 100 on its level of accuracy. The system 200 provides an interface to the requesting user to provide an indication that the response solves the location request. Once the requesting user provides such an indication, the system 200 updates the status of the location request as “resolved” and other users are no longer allowed to claim or respond to that same location request or earn any reward associated with it.

In some implementations, the system 200 may make the request unavailable for users to view or respond to over the collective network once the request has already been claimed by a responding user. In such implementations, the system 200 may create a set of dynamic rules, based on a variety of factors (e.g., responding user's proximity to the specified location, responding user's post history, timing of response, etc.), that determines which specific users may claim the request. In other instances, the system 200 may select the responding user that may claim the request based on the first user to submit a response, and make the request unavailable for other users until the request has been successfully fulfilled.

In some implementations, the system 200 may modulate the set of rules for claiming location requests based on external circumstances surrounding the location as well as the submission of the request. For example, the set of rules may contain weights associated with different factors (e.g., number of users near the location, time of day of the request submission, etc.), which may be attenuated or increased based on specific circumstances surrounding the request submission.

In some implementations, the requesting user may receive a list of candidate responses identified by the system 200 as having sufficient confidence levels to be adequately responsive to the location request. In such implementations, the requesting user may have the ability to choose the response to fulfill the request from the list of candidate responses. The system 200 may also present the requesting user with the responding user's post history (e.g., number of responses fulfilling, ratings from other requesting users, prior response history). Once the requesting user has made a choice, the system 200 may publish the specified response to the collective network and send a subsequent notification to responding users with unselected responses that their response had not been chosen by the requesting user.

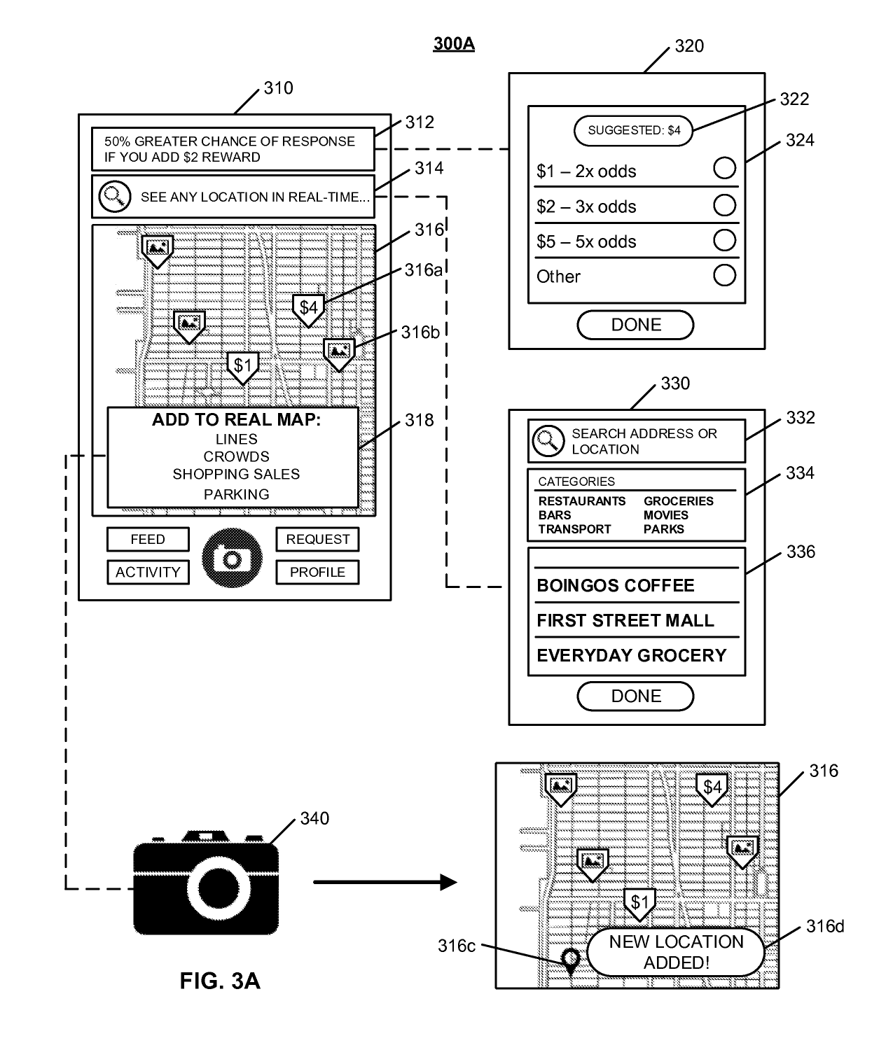

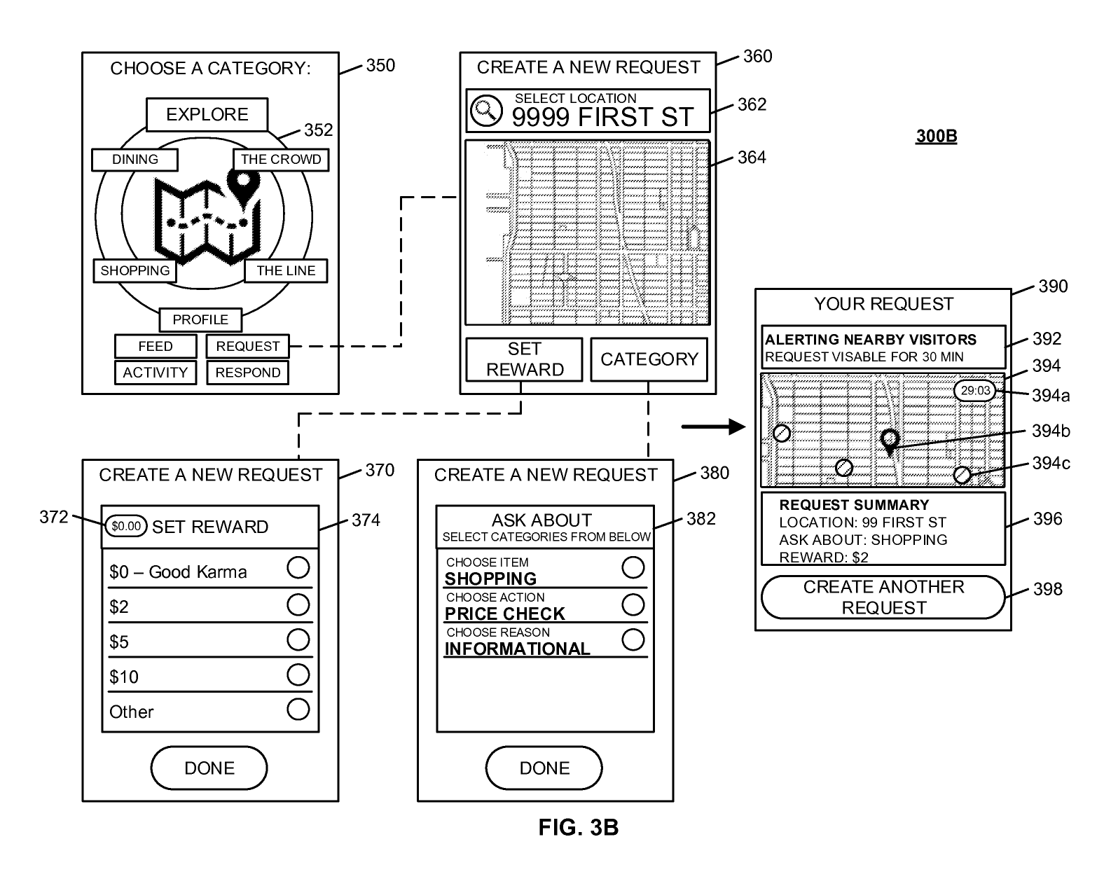

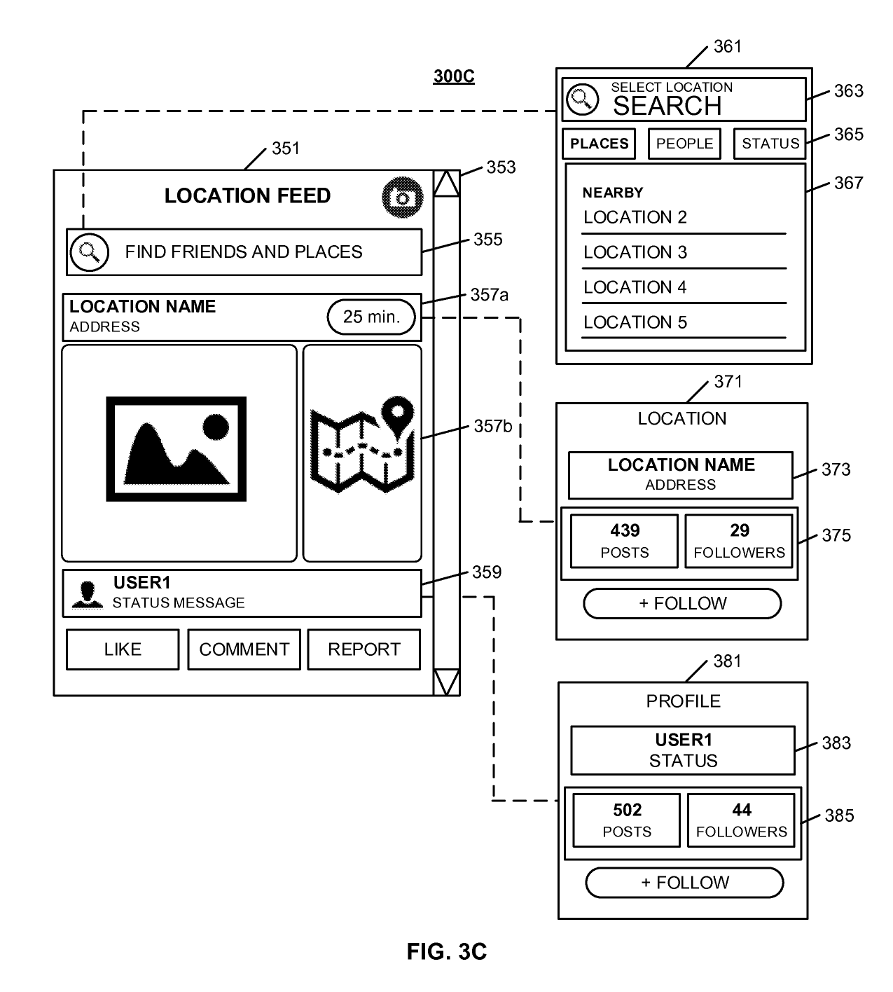

FIG. 3A is an exemplary user interface for a map environment used to track real-time location data. A user interface 300A is shown illustrating how a requesting user may submit a location request to the collective network. For convenience, particular components and messaging formats described earlier are referenced. However, similar methodologies may be applied in other implementations where different components are used to define the structure of the system, or where the functionality is distributed differently among the components shown. Although FIG. 3A represents a mobile application, FIG. 3A also may be presented in a graphical user interface (e.g., through a web browser).

The user interface 300A includes a map environment 310, a reward suggestion 320, a location search 330, and a camera application 340. While different interfaces may change depending on the configuration of the application, the user interface 300A illustrates an exemplary configuration to accepting user input for added a new location request to the collective network. In particular, the user interface 300A illustrates how the user may use a mobile application configured to display a map to view live location requests by other users, any recent photo posts by other users, and relevant information for nearby locations. Other user interfaces may include a location diagram, a user network visualization, a sorted list, or a combination of one or more of the aforementioned examples.

Generally, the map environment 310 represents one or more interfaces in the user interface 300A that are used to display location-specific information and allow a user to search for specified location, create new location requests, and create posts for new locations not included within the map environment 310. The map environment 310 may include a reward suggestion message 312, a location search field 314, a map 316, and a location addition field 318.

The reward suggestion message 312 provides the user with an option of adding a financial reward to the location request to increase its chances of a quick reply. In one implementation, the reward suggestion message 312 may provide an incentive system tied to location requests to allow requesting users to provide reward amounts to other responding users that respond to location requests. The reward suggestion message 312 may show predictions based on data aggregations from previous location requests and rewards as well as current, real time distribution of requests and users, to provide a response prediction based on similar requests that had previously been successfully responded to with specified reward amounts.

The location search field 314 allows the user to type text to search for specified locations that have previously been identified by other users and may be indicated in the map 316. In one implementation, the map 316 may update the display in real-time as the user types the text into the location search field 314 by applying a filter for locations to display within the map 316. For instance, the user may type the name of a location and the map 316 may dynamically update its display to narrow locations that match the search query provided by the user.

In another implementation, the search query may be used more dynamically to search multiple attributes of location (e.g., venue type, products offered, brands associated with a location). For example, the user may type the search query ‘coffee shop’ to display nearby coffee shops in the map 316. The map 316 may filter its display in real-time to narrow the displayed locations to only coffee shops that have previously been identified by other users within the collective network. In another example, the user may aggregate search queries to further narrow the search results displayed within the map 316. For example, the user may type the search query ‘coffee shop+latte’ to display locations that are identified as coffee shops and also carry a specific beverage product. In such examples, the user interface 300A may perform an algorithmic search query to parse prior location requests and responses for the specified venues to determine whether other users have identified the venue as carrying the specified product within the search query.

The map 316 displays all locations identified as presently associated with current location requests by other users within the collective network submitted through the user interface 300A. For example, the map 316 may a display icon 316a for location requests that have a reward amount, and an icon 316b for location requests where previous users have posted photos of the location. In other examples, the map 316 may display other relevant information associated with the location request (e.g., time remaining for the location request, type of request, etc.).

In some implementations, the map 316 may display location requests that are determined to be relevant to the user by performing trend analysis on the types of requests the user has previously submitted and the types of requests the user has responded to through the interface 300A. For example, the user interface 300A may only display location requests associated with restaurants based on determining that the user has previously only submitted responses to other users with restaurant locations requests. In another instance, a user may have the ability to create manual filters in a setting page (not shown) to automatically filter the map 316 to display specified location requests (e.g., certain reward amounts, certain types of locations, certain types of information requests). In such instances, the map 316 may be modulated to improve a user's access to relevant location information.

The location addition field 318 allows the user to add a location post to the collective network to voluntarily provide information about a location. For example, a user may use the location addition field 318 to add a location report for a new location not previously identified by other users within the collective network. In such examples, the user may have the option to choose the type of post (e.g., lines, crowds, sales shopping, parking) and automatically be routed to a camera application 340 to take a picture of the location to add to the map 310.

In some implementations, the user may only be allowed to add a location post if he is within a certain locality (e.g., within one mile radius). This enables the user interface 300A to accept only relevant location posts that are not from an earlier time period or from a distant geography. The user interface 300A may utilize the GPS location of the user's communication device to determine whether the user is within the specified locality from the address of the new location. In other implementations, if a user is unable to take an image of the location using the camera application 340, the user may be allowed to select an image from an online webpage that displays an image of the desired location.

Generally, once the user selects the reward suggestion message 312 within the map environment 310, the user may be rerouted to a reward suggestion 320, which includes suggested amount 322 and reward choice field 324. The reward suggestion 320 allows the user to select a reward amount based on predictions on chances for receiving a response to a location request. For example, the user interface 300A may calculate a suggested amount 322 based on previous location requests submitted to the specific location and current or trending distribution of requests and users in the present moment. In other examples, the user interface may calculate a suggested amount 322 based on previous location requests submitted to other locations with similar attributes (e.g., venue type, venue location, volume of location requests received, etc.).

The reward suggestion 320 also includes a reward choice field 324, which allows a user to specify either a suggested reward amount or a custom reward amount using radio buttons as an indication for a selected option. In one implementation, as represented in FIG. 2A, the reward choices displayed within the reward choice field 324 may consist of reward amounts that increase the likelihood of receiving a response to the location request. In such an implementation, the user interface 300A may calculate the probabilities of receiving a response by performing a permutation of previous location requests within the specified location or locations with similar attributes if no previous location requests exist. In another implementation, the reward choice field 324 may present other options to altering other aspects of the location request to increase the likelihood of receiving a response (e.g., response time desired, quantity or quality of information requested, etc.). In such implementations, the reward choice field 324 may present only specific attributes that have the greatest impact on the likelihood of receiving a response. For example, a user may submit a location request for a location that the user interface 300A has determined is most impacted by the request time. In such an example, the reward choice field 324 would consist of choices for specific reward times and corresponding probabilities for receiving a response based on response data from previous location requests.

Generally, when the user inserts a search query into the search field 314 within the map environment 310, the user may be routed to a location searcher 330, where the user may view his search query in search field 332, choose from various location categories in the location categories field 334, and select suggested locations from the location list 336. For example the user may insert the search query ‘coffee shop’ into the search field 332, and subsequently receive a set of categories for locations that are similar to coffee shops in location categories field 334, and a list of nearby coffee shops in location list field 336.

In one implementation, the location categories field 334 and the location list field are dynamically updated based on the user's text input within the search field 332. In such an implementation, the user interface 300A aggregates current data from the collective network and from previous location requests to determine appropriate category choices and location choices to display in the location categories field 334 and the location list field 336, respectively. For example, the user interface 300A may perform a trend analysis on all existing data within the collective network to determine categories and/or locations that may be associated with specific text that matches the search query. This allows the user to receive real-time, context-specific suggestions that may vary by time and location of the location request submission. For example, a user may receive different suggestions within the categories field 334 and location list 336, respectively, based on the current status of the data present within the collective network.

The location addition field 318 may allow a posting user to add location information to the map environment 316. In one example, the posting user may add a new location that is currently not specified within the map environment 316. In another example, the posting user may add new information for an existing location within the map environment 316. When the posting user selects the option to add location information using the location addition field 318, the posting user may be routed to a camera application 340, where the posting user may be able to capture a photo of the location. The posting user may post the captured photo onto the map environment 310 by submitting an accompanying post to the collective network. For example, the user may be outside a restaurant that is not currently identified within the collective network and wish to add the location to the map 316 by taking a picture of the restaurant and uploading a post with general location information to the collective network. In some implementations, the images taken by the camera application 340 may be analyzed by the user interface 300A for sufficient clarity using photo analysis and other processing techniques to determine if the image is a high-quality image. In other implementations, the images taken by the camera application 340 may be used to develop insights about physical locations (e.g., how busy they are, times when sales may occur, traffic predictions, parking availability). In such implementations, the user interface 300A may train such data from the camera application 340 to make predictions about specified locations and share such insights with original users and other others within the collective network. In another implementation, the camera application 340 may allow users to take videos of the location or to allow requestors to request live video feeds of the location. For example, a user may submit a location request for a house for sale and ask another user to provide a live feed of the property for a real-time tour over the user interface 300A. In such examples, live video may be recorded on the camera application 340 by a responding user and dynamically transmitted to the requesting user. The user interface 300A may further detect hardware configurations of the devices (e.g., network connection module, network bandwidth, screen resolution) and optimize video transmission settings to suggest various video configurations to the satisfaction of the requesting user.

In another example, the user interface 300A may develop a plug-in for web browsers and desktop applications based on the video feed captured by the camera application 340. In such an example, the link to the video feed may be accessible to users through a common advertising platform by creating a hyperlink to a plug-in for the user interface 300A. For instance, a posting user may publish a link to a location request with a video feed from the camera application 340. A responding user may subsequently access the video feed either through the map 316 within the user interface 300A or by accessing a public posting with a link to the video feed. Once the responding user accesses the location request, the requesting user may receive a direct phone call that may be initiated by the user interface 300A.

In another example, a posting user who runs a small business may use the video feed from the camera application 340 to conduct a product tour electronically through the user interface 300A. For instance, the posting user may publish a location request for a product (e.g., a bicycle) within a certain location (e.g., a bicycle store) and another user within the collective network may see an indication of the location request in the map 316. The user may interact with the post by providing a suggested purchase price and view a live video stream of the product using the camera application 340. In such instances, the user interface 300A allows users within the collective network to post and access specific products within specific time frames to prevent delays in purchases and/or sales.

Once a user has submitted an a image or video of the location using the camera application 340, the user is rerouted back to the map 316 with an icon 316c indicating the new location on the map 316 and a notification message 316d notifying the user that the post was successfully added. In some examples, the notification message 316d may also be utilized by the user interface 300A to indicate that a location was unsuccessfully added. In such examples, the user interface 300A may evaluate the sufficiency of the image or video submitted by the user using the camera application 340 or compare the submission to prior submissions by other users within the collective network to calculate a confidence level. The user interface 300A may provide a decline message through the notification message 316d if the confidence level of the submitted image or video is below a certain threshold required to add a new location to the map 316.

In one implementation, the user interface 300A may compare the submitted image or video by the user using the camera application 340 when creating a location post to existing images or videos submitted by other users of the collective network. In such an implementation, the user interface 300A may determine whether the submitted images or videos are relevant or are duplicates of existing data of the specific location. For example, if a user submits multiple photos within one location post, the user interface 300A may determine that the multiple photos represent a single or few discrete views and dynamically group the photos so other users within the collective network are not exposed to data redundancy. In another example, the user interface 300A may assess the relevancy of the submitted photos in real-time based on nearby location posts submitted to the collective network. For instance, if there is a major event taking place in a nearby location and majority of the location posts are dominated by specific topics and/or requests, the user interface 300A may prioritize those topics or posts and determine whether the instant image falls within the prioritized topics or requests. This enables the user interface 300A to maintain the context-specific relevancy of the collective network by utilizing an aggregate analysis of the location posts to prioritize relevant submissions over irrelevant submissions.

FIG. 3B is an exemplary user interface for creating a new location request. A user interface 300B is similar to the user interface 300A in that it allows a requesting user to create new location request and publish the request to the collective network. However, user interface 300B allows a user to specify information about the request in separate screens and allows the user to customize the location request. User Interface 300B includes segmented interface elements to make the location request creation process a more sequential process.

In particular, the user interface 300B includes a category selection page 350, a new request map page 360, a set reward page 370, a request specification page 380, and a request summary page 390. Specifically, the category selection page 350 includes a selection wheel 352, which allows the user to the type of information the request will include. For example, as represented in FIG. 3B, the user may request information about nearby restaurants using the ‘dining’ option, about entertainment and ticketing events using ‘the crowd’ option, about how a busy venue is using ‘the line’ option or nearby products or stores using the ‘shopping’ option. In some implementations, the center of the request selection wheel 352 may include a dynamic map that filters nearby requests and responses sent by other users within the collective network by the specific request type the user chooses. For example, a user may use the request specification page by using clockwise and counterclockwise hand gestures to switch between the specifications and the centered map may dynamically update the display accordingly based on the selected option. The category selection page 350 also includes navigational features to allow the user to switch pages within the user interface 300B.

When a user selects the ‘REQUEST’ button on the category selection page 350, the user may be routed to the new request map page 360, which allows the user to specify a location from a map 364 into a search field 362. The new request map page 360 may also allow the user to set an incentive for the new request by selecting the ‘SET REWARD’ button, which routes the user to the set reward page 370, or choosing a category for the request by selecting the ‘CATEGORY’ button, which routes the user to the request specification page 380. The map 364 may display all nearby requests within a specific locality (e.g., one mile radius) or show previous requests by the user within a certain time period (e.g., 24 hours). In some implementations, the map 364 may dynamically update based on the search query inputted by the user into the search field 362.

Generally, the set reward page 370 may include a reward field 374, which allows the user to specify a selected reward amount, and a suggested reward amount 372, which is a predicted amount determined by the user interface 300B based on previous location requests submitted by other users in the current location or other locations with similar attributes. In one implementation, offering a reward is optional and the user may wish to submit a “GOOD KARMA” option, which does not provide a monetary amount to a successful response to the location request. In another implementation, offering a cash reward initiates a transaction by the interface 300B to withdraw a specified balance from the specified payment method within a registered user account within the local network. In such an implementation, the withdrawn amount (e.g., $2) may be held in escrow pending the outcome of the location request. Once the request is claimed by a responding user in the collective network, the responding user may have a time window specified by the requesting user to submit information requested.

In some implementations, the user interface 300B may limit the claiming ability of responding users to maximize the chances of successfully responding to the location request. In such implementations, the user interface 300B may compare the real-time displacement between the responding users' communication device to the location specified within the location request to predict the speed at which the user may arrive at the location. The user interface 300B may also dynamically determine, based on the responding users' past request and response history, the likelihood of each responding user that claims the reward to successfully complete the location request.

In some implementations, the reward is successfully earned if the requesting user is satisfied by the response by reviewing the response and pressing an ‘ACCEPT’ button (not shown). In such implementations, the user interface 300B may transfer the funds from the escrow to the responding users account as either user credit within the user interface 300B or directly to a bank account associated with the user account within the collective network. In some implementations, a cancelled location request prior to claiming by responding agent, or a unsuccessful response, may result in a partial or total reimbursement/payment to either the requesting user or the responding user, based on different factors (e.g., how long the requesting party waiting before canceling the location request, the distance traveled by the responding party after claiming the request, etc.).

Generally, the request specification page 380 includes a category field 382, which allows the user to choose from a list of categories that may be associated with the search query entered by the user into the search field 362. For example, as represented, the user may be presented with a type of request item such as shopping, an action based on the item as a price check, and a reason for the request such as information needed. The category field 382 allows the user to create attributes for the current location request that may be used by the interface 300B in subsequent location requests to track the user's historical data or perform data aggregation functions based on the specified attributes of individual location requests. For example, the user interface 300B may utilize the item attribute to determine the most popular types of location requests, and design insights for users based on associating items with specific types of locations. In another example, the user interface 300B may use the actions attribute to determine user preferences by determining common actions represented within the user's location history. In yet another example, the user interface 300B may utilize the reason attribute to derive the descriptiveness required to successfully submit a location request by comparing the number of characters within a location request against the probability of success within similar request types.

Once the user has selected a reward through the set reward page 370 and specified the attributes of the request through the request specification page 380, the user may be routed to the request summary page 390 to review the details of the new location request about to be created. Generally, the request summary page 390 includes alert notification 392, a map 394, a request summary field 396, and create request button 398. The alert notification 392 notifies the user that the specified new request will be published to the collective network for other users to claim and allows the user to specify a time period for which the request will remain active (e.g., appear published to other users). The map 394 includes an stopwatch 394a, which allows the user to see how long the request is still active for, an icon 394b, which indicates the location of the new request, and one or more icons 394c, which display the location of nearby users in relation to the location request.

The request summary field 396 includes all the information that the user has submitted within the location request through the user interface 300B. For example, as indicated, the request summary may include the location, the reward amount and the attributes of the request. In some implementations, the user may be able to modify the details directly for a certain time period after creating the request by selecting the request summary field 396 and updating the specific field. In such implementations, the user may be unable to update the request details after a responding user has claimed the request and initiates the process of completing the location request. Finally, the renew request button 398 allows the user to return to the category selection page 350 to reinitiate the location request creation process to create a subsequent new location request.

FIG. 3C is an exemplary user interface for a location feed used to monitor context-based data within a location. User interface 300C is similar to the user interface 300A and the user interface 300B in that it allows the user to input relevant information about location requests and location posts, and publish such information to the collective network for other viewers to access. However, the user interface 300C specifically allows users to visualize relevant posts submitted about locations using a location feed to aggregate all posts related to a specified location and consolidate different types of data submitted by multiple users into segmented views that allows users to determine time-specific and context-specific information.

In general, the user interface 300C may include a location feed 351, a location search 361, a location summary 371, and a user profile 381. Specifically, the location feed 361 allows users to receive alerts about relevant events in nearby locations (e.g., social event at night club). The location feed 351 represents posts within a certain time frame (e.g., two hours) to preserve the relevancy of the data to the user viewing the location feed 351. For example, the posts visualized for a particular location in the location feed 351 may vary by the time of day it is accessed based on the time-specific activity of the location itself. For instance, a restaurant may show posts related to food menus or pricing during the day, and may show posts for drink specials and/or happy hour options in the evening when the restaurant functions more like a bar or nightclub. In another example, the posts visualized may be tailored to the user accessing the location feed 351 based on user preferences, user activity or user behavior. For example, the user interface 300C may determine based on the user's location requests and activity, the specific venues that the user is interested in as well as the type of requests that are most relevant to the user. In such an example, the user interface 300C may use data aggregation and trend analysis techniques to derive insights about the users activity and prioritize posts within the location feed 351.

Generally, the location feed 351 includes a scroll bar 353, search field 355, a location field 357a, content feed 357b, and a user field 359. The scroll bar 353 allows the user to navigate vertically or horizontally through the location feed 351 and view multiple posts in regards to the same location. For example, a user may use the scroll bar 353 to look at minute-by-minute updates of a sports game to determine how users are reacting to events within the game.

The location field 357a, and the content feed 357b display information within posts about the location itself. For example, the location field 357a may include the name of the location and the address and a timestamp of the post to notify the user of how long ago it was posted. In addition, the content feed 357b may show images or photos submitted to the user interface 300C by a posting user. For example, as indicated, the content feed 357b may include an image and a GPS location signal, which allows a user to compare an image to a specified location. For instance, a user may post a picture from a concert hall and pin their location within the concert hall, and a subsequent user may post a picture form a different part of the concert hall and pin their location as well. Subsequently, a user navigating through the location feed 351 may then view the posts with pictures from different vantage points within the same location.

The user field 359 displays information about the posting user and a text message from the post. In some implementations, the message may include a hashtag from a trending event or a common status for a specific event within the location (e.g., a show). In such implementations, the user interface 300C may use the common statuses to identify common trends or preferences amongst multiple users within the same location by aggregating multiple posts submitted by different users within the same location. The user interface 300C may also track user interactions such as ‘likes’, ‘comments’ or ‘reports’ to identify user preferences and/or user interactions between multiple users.

In one implementation, a user may post a live video feed directly onto the location feed 351 using the content feed 357b to other users accessing the location feed 351 or through an application program interface to an external social media profile page (e.g., Facebook, Twitter) that is separate from the interface 300C. For example, an event promoter may stream a live video feed of a concert within a concert hall onto the location's webpage online to share the feed to the public. In such an example, the user interface 300C may allow content consumption in real-time by creating a single platform to access real-time, context-specific data transmitted to a plurality of users within a collective network.

In another implementation, a user may use the location feed 351 to stream live video through a wearable camera through the content feed 357b to share a point-of-view experience with users accessing the location feed through the user interface 300C. In other implementations, the location feed 351 may be used to crowdsource time-sensitive newsworthy information using the rewards, as previously discussed, as an incentivized model to support user submissions. For example, nearby users may use the location feed 351 to publicize direct access to newsworthy information without delay in transmission based on the location-based capture features of the location feed 351. In such instances, users accessing the location feed 351 may have access to time-sensitive information much faster than traditional news sources that are broadcasted online or through cable sources.

Once a user selects the search field 355, the user may be routed to a location search 361. The location page 361 includes a search field 363, one or more buttons 365, and a location field 367. A user may utilize the one or more buttons to access relevant data nearby the search query entered into search field 363. For example, if a user search ‘concert’, the location field 367 may display nearby locations within a specified locality that may match the query based on other location requests and posts submitted by other users. The user may also utilize the one or more buttons 365 to filter the search results by places, people or status to visualize the results appropriately.

Once the user selects the location field 357a or the user field 359, the user is directed to the location summary 371, and a user profile 381, respectively. The location summary 371 includes relevant information about the location such as location name 373 and the post summary 375. The user may access the post summary 375 to see common posts about the location or the users that frequently post about the location. For example, a user may look at the posts and followers of a restaurant to search for reviews of the menu, or what type of users regularly post about the restaurant to determine if it matches with their personal preferences. The user may also follow the location to receive constant notifications about the location when another user submits a post related to the location.

The user profile 381 includes user name 383 and post summary 375. As indicated above with the location summary 371, the user profile 381 allows the user to determine posting history related to the specific user.

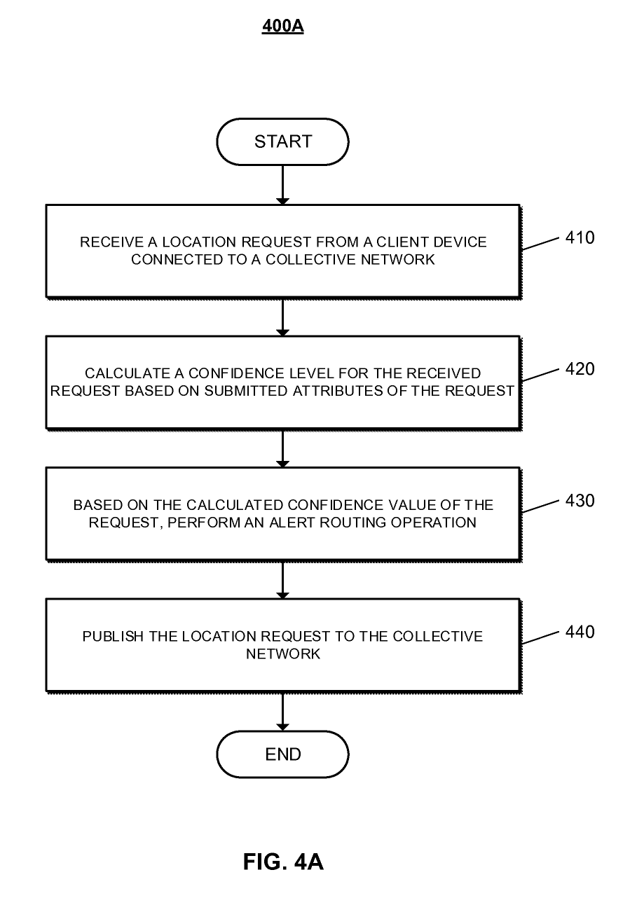

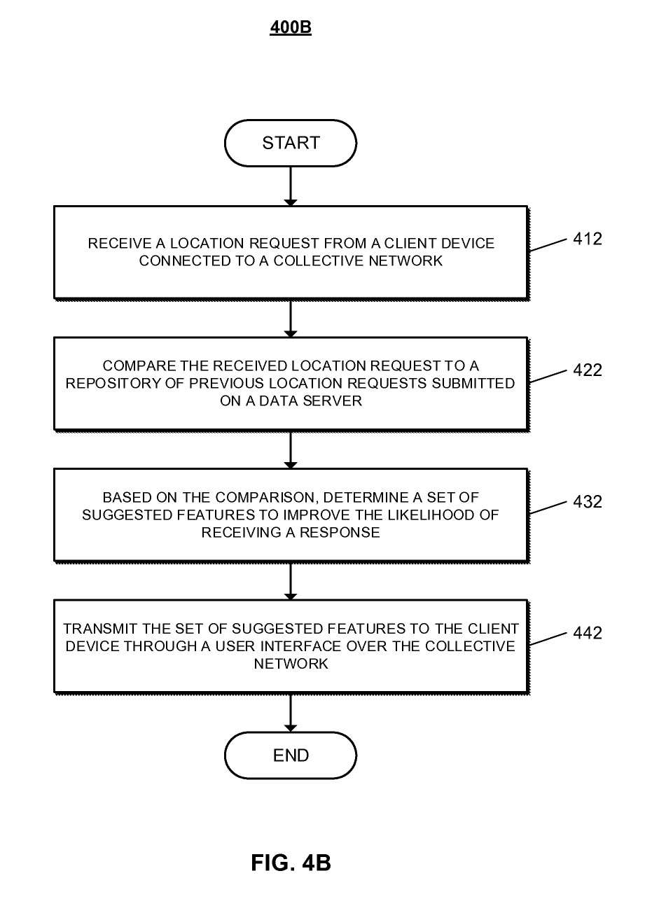

FIG. 4A shows an exemplary flow diagram illustrating a calculation of a confidence level for a location request. Briefly, the system receives a location request from a client device connected to a collective network (410). The system calculates a confidence level for the received request based on submitted attributes of the request (420). Based on the calculated confidence level of the request, the system performs an alert routing operation (430). The system may publish the location request to the collective network (440).

The operations of the example process 400A are described generally as being performed by the system 100. The operations of the example process 400A may be performed by one of the components of the system 100 (e.g., the client device 112, the data server 130, the user interface 130, etc.) or may be performed by any combination of the components of the system 100. In some implementations, operations of the example process 400A may be performed by one or more processors included in one or more electronic devices.

The system receives a location request from a client device connected to a collective network (410). For example, the system 100 may receive a location request 116 from a client device 112 connected to the collective network 110.

The system calculates a confidence level for the received request based on submitted attributes of the request (420). For example, the system 100 may perform a multi-factorial analysis on the information within the location request to determine the reliability and the accuracy of the information. For instance, if the location request includes an image of the location, the system 100 may determine whether the image corresponds to the location specified by cross-referencing the picture to external sources (e.g., webpages of the vendor, prior location requests from other users), to determine if the image accurately represents the location. In another instance, the system 100 may analyze the image clarity by individually parsing the pixels of the image to determine whether the location may be visually represented within the image.

In some implementations, the system 100 may also perform a trend analysis of the user submitting the location request. For example, the system 100 may access the request history 150 and determine whether the instant location request is a proper request by tracking the user's previous requests, calculating the percentage of successful requests and the quality of information provided in previous location requests. In another example, the system 100 may use the request history 150 to compare the instant location request with other location requests for the same location submitted by other users. In yet another example, if no comparable location requests exist for the user or the location, the system 100 may compare the instant location request to other location requests of similar attributes (e.g., similar location, similar location type, similar location requests submitted).

Based on the calculated confidence level of the request, the system performs an alert routing operation (430). For example, the system 100 may compare the calculated confidence level to a threshold values to determine appropriate routing actions to take. For instance, the system 100 may prioritize location requests based on the confidence level and initiate actions with prioritized location requests first. For example, a user may indicate distinct notification settings (e.g., push notification, SMS alerts, emails) based on the reward amount set with the location request. In such an example, the system 100 may transmit location requests using different communication methods based on the confidence level of the location requests.

In some implementations, the system 100 may transmit the location requests to specific users based on the instant location of the users in relation to the location specified. For example, users within a certain locality to the location request (e.g., one mile radius) may initially receive the location request prior to other users on the collective network to maximize the likelihood that the request may be claimed by a user that is nearby the location.

In some implementations, the system 100 may determine transmission to specified users using specialized communication beacons within locations such as near-field communication or Bluetooth to determine when a user is inside the location of interest.

The system may publish the location request to the collective network (440). For example, once the system 100 has determined that location request has a sufficient confidence level to be appropriately accurate and reliance, and the proper routing technique, the system 100 may publish the location request onto the collective network 110 so that users may access it using the user interface 130.

In some implementations, the system 100 may determine claim rules in determining which users may appropriately claim the request once it has been published onto the collective network 110. For example, the system 100 may perform a location validation to ensure that the potential responding users are within a specified locality to the specified location. In other examples, the system 100 may determine a hierarchy of claiming rules based on the mode of transportation the responding user uses. For example, users in cars may receive location requests prior to users that are walking to improve the likelihood that the user in the car will approach the location faster than the user walking. In such examples, the system 100 may modulate the alerting rules based on the requesting user's demands such as notification preferences, timing for a response as well as preferred means of contact.

FIG. 4B shows another exemplary flow diagram illustrating predictive modeling of a location request. Briefly, the system receives a location request from a client device connected to a collective network (412). The system compares the received location request to a repository of previous location requests submitted on a data server (422). Based on the comparison, the system determines a set of suggested features to improve the likelihood of receiving a response (432). The system transmits the set of suggested features to the client device through a user interface over the collective network (442).

The operations of the example process 400B are described generally as being performed by the system 100. The operations of the example process 400B may be performed by one of the components of the system 100 (e.g., the client device 112, the data server 130, the user interface 130, etc.) or may be performed by any combination of the components of the system 100. In some implementations, operations of the example process 400B may be performed by one or more processors included in one or more electronic devices.

The system receives a location request from a client device connected to a collective network (412). For example, the system 100 may receive a location request 116 from a client device 112 connected to the collective network 110.

The system compares the received location request to a repository of previous location requests submitted on a data server (422). For example, as previously discussed, the system 100 may compare the attributes of the location request (e.g., type of location, type of action requested, time frame requested) to a request history 150 that contains a repository of previous location requests submitted by all users of the collective network 110.

Based on the comparison, the system determines a set of suggested features to improve the likelihood of receiving a response (432). In one example, the system 100 may determine duplicate location requests by identifying similar attributes or similar combination attributes for the same location within a certain period of time (e.g., within 5 minutes). In one implementation, the system 100 may submit a suggestive notification to the requesting users that other users have submitted a similar location request and route the identified users to a separate request page with all users identified to have submitted common requests to split reward amounts for the location request.

In another example, the system 100 may preemptively send suggestions of requests to users based on various factors such as time of day, user history, system metrics, user's current location, or trending topics within the collective network. For example, if the user is nearby a popular venue, the system 100 may suggest a list consisting of location requests previously submitted by users for popular venue based on the user's proximity to the popular venue.

The system transmits the set of suggested features to the client device through a user interface over the collective network (442). For example, the system 100 may transmit a notification on the user interface 130, which is accessed by a user through a client device 112. In one example, the system 100 may suggest similar features to the existing location request that may be triggered by numerous factors such as the user's location while creating the new location request, the action specified within the location request, or type of venue indicated within the location request. For example, if a user is creating a new location request for a specific coffee shop, the system 100 may determine, based on the user's present location, that there may be five other coffee shops of interest and transmit a notification message indicating that there may be other coffee shops related to the coffee shop indicated within the location request.

In another example, the system 100 may send push prompts to the user based on the user's activity within the location feed 134. For example, a user may post a message on the location feed about a specific activity, and the system 100 may track the post to determine that there may be another relevant activity that the user may be interested in based on the post within the location feed 134. In such an example, the user may receive a prompt in their communication device suggesting an activity they may be interested.

Various implementations of the systems and methods described here can be realized in digital electronic circuitry, integrated circuitry, specially designed ASICs (application specific integrated circuits), computer hardware, firmware, software, and/or combinations of such implementations. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A computer-implemented method of presenting requests related to a location to users within a collective network, the method comprising:
receiving, from a first user within a collective network, a request identifying (i) a location and (ii) a request for information related to the location;
publishing the request on the collective network with a status indicating whether the request has been fulfilled;
providing, for a plurality of users within the collective network, a user interface for responding to the submission from the first user;
receiving, from a second user within a collective network, a response including information related to the location;
determining the responsiveness of the response to the request based on at least the included information related to the location; and
in response to determining the responsiveness of the response, updating a status for the request indicating that the request has been fulfilled.

2. The method of claim 1, wherein providing a user interface for a plurality of users comprises providing, by a server computer system, a transmission to a client device to provide a user interface.

3. The method of claim 1, wherein providing the user interface for responding to the request comprises providing a map user interface identifying (i) an interactive icon indicating the location of the request, (ii) the request for information related to the location, and (iii) the status of the request submitted by the first user.

4. The method of claim 1, wherein publishing the request on the collective network comprises publishing the request with a reward amount for providing a response to the request with a high responsiveness.

5. The method of claim 1, comprising calculating a confidence level of the received request, wherein the confidence level of the received request reflects a likelihood that one or more users within the collective network will respond to the request.

6. The method of claim 5, comprising:
comparing the confidence level for the received request to a threshold value for the confidence level;
determining that the confidence level for the received request is lower than the threshold value; and
based on at least determining that the confidence level for the received request is lower than the threshold value, determining that that the received request is invalid.

7. The method of claim 1, wherein determining the responsiveness of the response comprises calculating a confidence level of the response, wherein the confidence level of the received response reflects a likelihood that the response includes information identified as satisfying the request.

8. The method of claim 1, wherein after receiving the request including information related to the location, performing a routing operation directed towards a plurality of users within the collective network.

9. The method of claim 8, wherein performing the routing operation directed towards a plurality of users within a collective network is based at least on a confidence level of the received request, wherein the confidence level of the received request reflects a likelihood that a second user within the collective network will respond to the request.

10. The method of claim 9, wherein the routing operation comprises prioritizing the publishing of the received request based at least on the number of other requests received over the collective network within a particular time period, determining the number of users within a particular distance from the location referenced in the received request.

11. The method of claim 1, comprising:
generating a set of suggested features for the request to improve the likelihood of receiving a response based at least on determining the number of users within a particular distance from a location referenced in the received request; and
providing, by a user interface, the set of suggested features to the first user.

12. The method of claim 1, comprising:
before the second user submits the response, determining a distance score between a location of the second user and the location identified in the request;
determining that the distance score between the GPS location of the second user and the location identified in the request is below a threshold value;
in response to determining that the distance score between the location of the second user and the location identified in the request is greater than the threshold value, determining that the second user is ineligible to claim the request;

13. The method of claim 12, comprising:
after receiving the response from the second user including information related to the location identified in the request, determining a second distance score between a location of the second user and the location identified in the request;
determining that the second distance score between the location of the second user and the location identified in the request is below a threshold value; and
in response to determining that the second distance score between the location of the second user and the location identified in the request is greater than the threshold value, determining that the response is invalid.

14. The method of claim 1, comprising:
receiving context data from the plurality of users over the collective network;
determining a likely context associated with the plurality of users, based on at least a portion of the context data;
receiving context data from the second user over the collective network;
determining a likely context associated with the second user, based on at least a portion of the context data;
comparing the likely context associated with the plurality of users with the likely context associated with the second user;
determining that the likely context associated with the plurality of users is relevant to the second user, based at least on comparing the likely context associated with the plurality of users with the likely context associated with the second user;
selecting one or more notifications to send to the second user based at least on determining that the likely context from the plurality of users is relevant to the second user; and
providing, by a user interface, the one or more selected notifications to the second user.

15. The method of claim 14, wherein selecting one or more notifications to send to the second user comprises:
determining the likely context associated with the second user based at least on (i) the location of the second user within the collective network, or (ii) information consumed by the plurality of users over the collective network;
in response to determining the likely context associated with second user, selecting one or more notifications to send to the second user.

16. The method of claim 14, wherein the context data from the plurality of users includes location information submitted to the collective network within a particular period of time.

17. The method of claim 15, wherein the one or more selected notifications to the second user includes suggestions to submit information to the collective network.

18. A system comprising:
one or more computers and one or more storage devices storing instructions that are operable, when executed by the one or more computers, to cause the one or more computers to perform operations comprising:
receiving, from a first user within a collective network, a request identifying (i) a location and (ii) a request for information related to the location;
publishing the request over the collective network with a status indicating whether the request has been fulfilled;
providing, for a plurality of users within the collective network, a user interface for responding to the submission from the first user.
receiving, from a second user within a collective network, a response including information related to the location;
determining the responsiveness of the response to the request based on at least the included information related to the location; and
in response to determining the responsiveness of the response, updating a status for the request indicating that the request has been fulfilled;

19. The system of claim 18, further comprising calculating a confidence level of the received request, wherein the confidence level of the received request reflects a likelihood that one or more users within the collective network will respond to the request.

20. The system of claim 19, further comprising:
comparing the confidence level for the received request to a threshold value for the confidence level;
determining that the confidence level for the received request is lower than the threshold value; and
based on at least determining that the confidence level for the received request is lower than the threshold value, determining that that the received request is invalid.
